(19) United States
(12) Patent Application Publication
(10) Pub. No.: US 2009/0032379 A1
(43) Pub. Date: Feb. 5, 2009

(54) AUTOMATED CONTROL MODULE FOR ELECTRICAL CUT-OFF APPARATUS AND ELECTRICAL CUT-OFF APPARATUS EQUIPPED WITH SUCH A CONTROL MODULE

(75) Inventors: Jean-Luc Hamm, Kuttolsheim (FR); Jean-Pierre Frantzen, Sand (FR)

Correspondence Address: DAVIS & BUJOLD, P.L.L.C., 112 PLEASANT STREET, CONCORD, NH, 03301, US

(73) Assignee: SOCOMEC S.A., Benfeld (FR)

(21) Appl. No.: 12/281,393

(22) PCT Filed: Feb. 6, 2007
(86) PCT No.: PCT/FR2007/000209

§ 371 Date: Sep. 18, 2008

(30) Foreign Application Priority Data
Mar. 3, 2006 (FR) 06/01902

(51) Int. Cl. H01H 3/40

(52) U.S. Cl. 200/501

(57) ABSTRACT

An automated control module for an electrical cut-off apparatus including an automated actuation mechanism (30) having two electromagnets (31) aligned in opposition on a slide (34) bearing a rack (35) which meshes with a driving pinion (40). The driving pinion (40) can rotate about a drive spindle (50) which is intended to be rotationally coupled to the drive shaft of the cut-off apparatus (1). The drive spindle (50) includes a ratchet wheel (51) driven in one direction or another by pawls (43) fastened to the driving pinion (40) so as to switch the cut-off apparatus (1) according to the controlled electromagnet. This control module (10) also includes a manual actuation mechanism (60) and automatic clutch mechanism for disengaging one of the mechanisms (30 or 60) when the other mechanism is in operation.

This application is a National Stage completion of PCT/FR2007/000209, filed Feb. 6, 2007 which claim priority from French Patent Application Serial No. 06/01902, filed Mar. 3, 2006.

### TECHNICAL FIELD

The present invention relates to an automated control module for an electrical cut-off apparatus, this electrical cut-off apparatus includes a rotary drive shaft. This control module includes a housing in which an automated actuation mechanism for the rotation of said control axis is seated, equipped with at least one translation actuator, with a device converting the translational movement of the actuator into a rotary movement and with a device transmitting the rotary movement to said drive shaft. The present invention also relates to an electrical cut-off apparatus equipped with such control module.

### BACKGROUND ART

The electrical cut-off apparatuses concerned by the invention are two-position 0-I circuit-breakers, two-position I-II switches, three-position I-0-II switches, I-I+II-II overlay switches or similar devices. These electrical cut-off apparatuses usually include one or several stacked cut-off modules. The cut-off modules are of a known type and include moving contacts actuated by means of a rotary drive shaft by way of a conversion mechanism using a cam or a similar device. To carry out a “switching” function, for example in the case of a power supply switching between the mains network and an emergency power generating unit, two cut-off modules mounted in parallel and connected each to a power supply source are used, the control module being either manual or automated for large industrial circuit-breakers or switches. Automation is generally carried out using an electrical geared motor whose drive shaft is coupled, via a transmission, with the drive shaft of the switch-off modules.

This well-known technology has many drawbacks. Due to its high cost, it is not suitable for small-sized cut-off apparatuses. Its relatively large dimensions require oversizing the control module and this affects the volume of the whole cut-off apparatus. In addition, it requires a specific electrical power supply to feed the motor, thus switching it off in case of a power failure and making the control module inoperative. Finally, this kind of motorization has an own inertia which lengthens the switching times, and this can be detrimental to the apparatus itself. If one wishes to switch to manual mode, it is necessary to move also the geared motor or to disengage it, which imposes higher drive torques or additional mechanisms.

The publication DE-C-574 857 describes another technology applied to an oil-immersed switch intended for high-voltage networks. The control mechanism of this switch includes a compressed aid jack whose piston rod forms a rack meshing with a pinion coupled to the drive shaft of the switch by means of a ratchet wheel and pawls allowing driving it only in one direction of rotation, the piston rod being also controlled by a return spring. This type of pneumatic jack actuator has the major drawback that it requires a specific and regulated compressed air supply, as well as connecting means and solenoid valve control means, which also need to be controlled. So this control mechanism is very complex, expansive and is not suitable at all for low and medium high voltage, small-sized electrical distribution. Furthermore, the efficiency of this control mechanism is mediocre, its switching quality is uncertain and its axial dimensions are very large.

### PRESENTATION OF THE INVENTION

The present invention aims to remedy the drawbacks mentioned above by offering an automated control module which can be autonomous, i.e. without specific power supply, simple, inexpensive, compact, requiring few parts, without inertia and thus offering ultra short response times as well as a very good efficiency, ensuring an excellent switching reliability and offering many possible switching combinations and a wide range of applications.

To this purpose, the invention relates to a control module as defined in the preamble, characterized in that said actuator is provided with at least one electromagnet, in that said movement conversion device includes at least one slide coupled to said electromagnet, provided with a rack meshing with a driving pinion, this driving pinion being arranged to be coupled to said drive shaft by means of said transmission device in at least one working position when the electromagnet is powered electrically, when said control module is assembled with said electrical cut-off apparatus.

The use of an electromagnet as an actuator allows reaching switching speeds lower than 50 ms in order to limit the “electrical blackout”.

The electromagnet advantageously includes a plunger coupled to said slide and pulled back in idle position by return means when the electromagnet is not powered electrically, these return means can be located between the housing and the slide. This way, the idle position is a stable position maintained without energy.

Furthermore, the electromagnet can be powered electrically directly by the cut-off apparatus it is associated with, thus ensuring its energetic autonomy.

The control module includes preferentially a manual actuation mechanism located in said housing, aligned with said automated actuation mechanism, this manual actuation mechanism being provided with a gripping element which can be operated by an operator from the outside of said housing, and with a transmission device to said drive spindle.

This control module includes advantageously automatic disengagement means to disengage the manual actuation mechanism when the automated actuation mechanism is in operation, and conversely, without intervention of an operator.

This objective is also reached by an electrical cut-off apparatus characterized in that it includes a control module as defined above.

### BRIEF DESCRIPTION OF THE DRAWINGS

The present invention and its advantages will appear better in the following description of an embodiment given as a non-limiting example, referring to the enclosed drawings, in which:

FIG. 1 is a general view of a cut-off apparatus equipped with a control module according to the invention;

FIG. 2 is a perspective view of the control module of FIG. 1;

FIG. 3 is an exploded view of the control module of FIG. 2;

FIG. 4 is a top view of the control module of FIG. 2, with the cover opened;

FIG. 5 is a top sectional view of the actuation mechanism of the control module of FIG. 2;

FIG. 6 is a perspective view of the automated actuation mechanism;

FIG. 7 is a perspective view of the manual actuation mechanism;

FIGS. 8A-E are front views of the automated actuation mechanism in various states;

FIG. 9 is an exploded view of a part of the manual actuation mechanism of FIG. 7;

FIGS. 10A-C are partial front views of the manual actuation mechanism of FIG. 9 in various states, before switching,

FIGS. 11A-C are complete views similar to FIGS. 10A-C after switching; and

FIGS. 12A and 12B are front views of the padlocking device of the control module according to the invention.

### BEST WAY OF CARRYING OUT THE INVENTION AND INDUSTRIAL APPLICATION POSSIBILITY

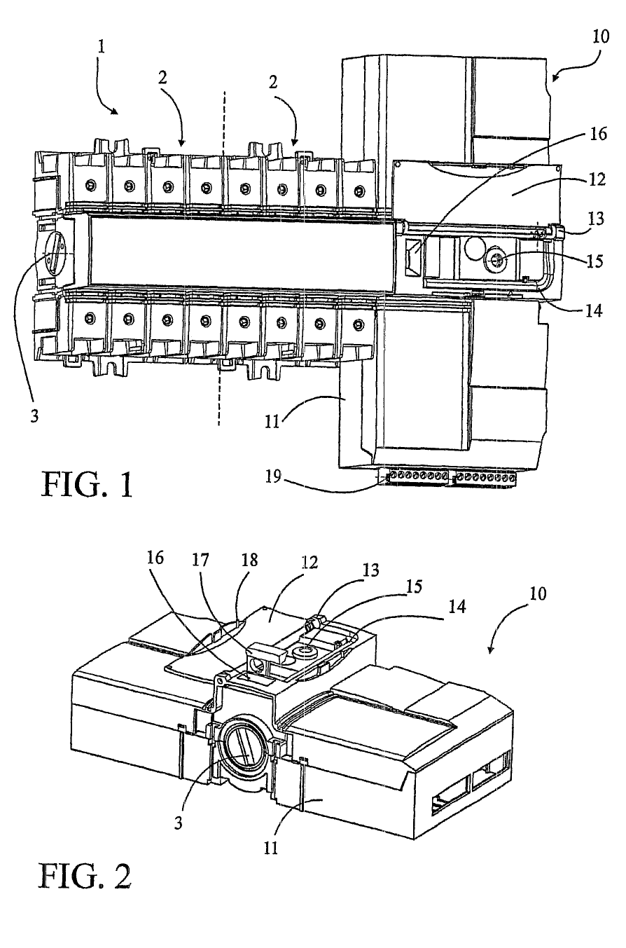

Referring to the figures the automated control module 10 according to the invention is intended to equip electrical cut-off apparatuses 1 of a known type, such as two-position 0-I circuit-breakers, two-position I-II switches, three-position I-0-II switches, I-I+II-I overlay switches or similar devices. An example of a cut-off apparatus 1 is illustrated by FIG. 1 and includes two cut-off modules 2 stacked and associated with a control module 10. The number of cut-off modules 2 may be different and depends on the use of the cut-off apparatus 1. The cut-off modules 2 include in a known way moving contacts; and anvil contacts, the moving contacts being actuated, by way of a cam system or any equivalent system, by a rotary through drive shaft (not represented). This drive shaft is designed to be rotationally coupled to the actuation mechanism of an automated and/or manual control module on one hand and, on the other hand, with another drive shaft in case of stacked cut-off modules 2. In the present invention, the drive shafts of the cut-off modules 2 are designed to be rotationally coupled to each other and to the control module 10 by means of a mechanical coupling part 3 of the Oldhamr type or of a similar type, which has the advantage of being a simple coupling requiring no accurate alignment of the drive shafts.

The control module 10 according to the invention includes an actuation mechanism which allows automating the actuation of the drive shaft and thus the switching of the cut-off apparatus 1 between its various states. Consequently there exist two variants of embodiment of this control module 10: a first variant of embodiment suitable for circuit-breakers or switches with two stable positions and a second variant of embodiment suitable for switches with three stable positions. In all cases, the control module 10 includes a housing 11 with a parallelepipedic general shape and designed advantageously in a standard way in order to be common to the various variants of embodiment, the following description relating to a control module 10 for a switch with three stable positions I-0-II.

This housing 11 includes two half shells assembled by fitting and by screwing them together or by a similar method, manufactured preferably by casting of electrically insulating synthetic materials. It includes on the front side a preferably translucent cover 12, mounted tilting around a hinge 13 to give access to a wrench 14 allowing to operate the control module 10, in manual mode, by inserting it in a receptacle 15 of a manual actuation mechanism 60, which will be described in detail later. This wrench 14 may be replaced with any other equivalent gripping element such as an integrated or mounted handle. It also includes on the front side a window 16 allowing to visualize the switching state of the cut-off apparatus 1: I, 0 or II, i.e. the position of the contacts, a padlocking tab 17 which allows locking the control module 10 in one switching state of the cut-off apparatus 1 or the other. Furthermore, the cover 12 is coupled with a micro-switch (not represented) actuated by a pin 18 to inhibit the operation of the control module 10 in automated mode as long as the cover 12 is open. Any other equivalent safety means may be suitable. This housing 11 also includes a terminal block 19 for the electrical connection of the power supply and of the control of the automated actuating mechanism 30 described in detail below.

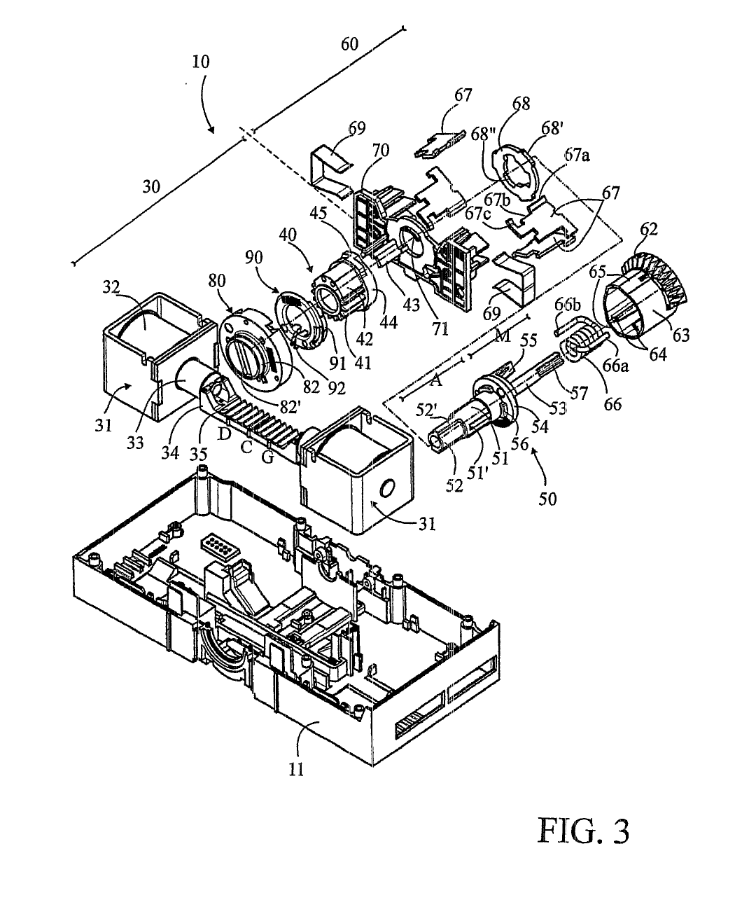

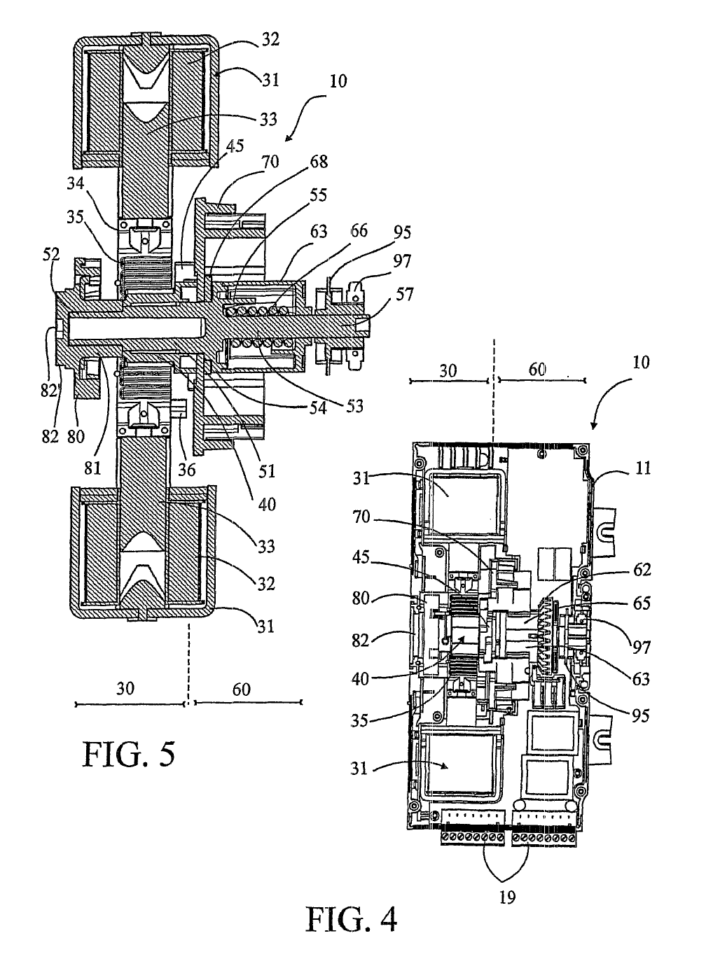

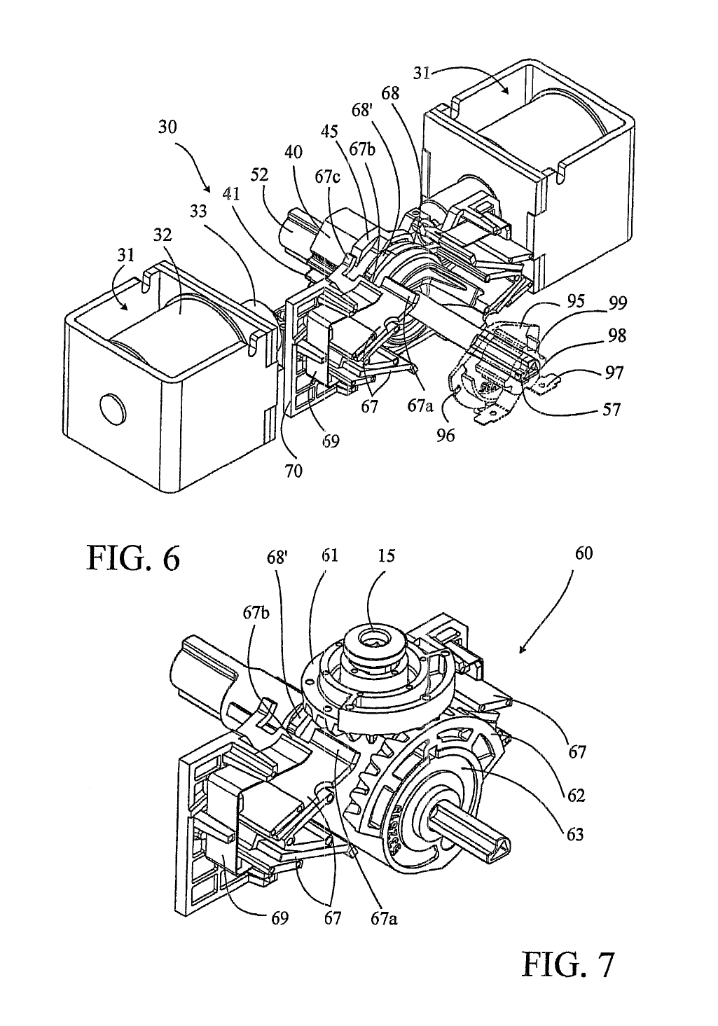

Referring to FIGS. 3 to 7, the control module 10 includes a first actuation mechanism called “automated” 30, intended to be coupled directly to the drive shaft of the cut-off apparatus 1 by means of a mechanical coupling 3, followed by a second actuation mechanism called “manual” 60 arranged aligned with the first.

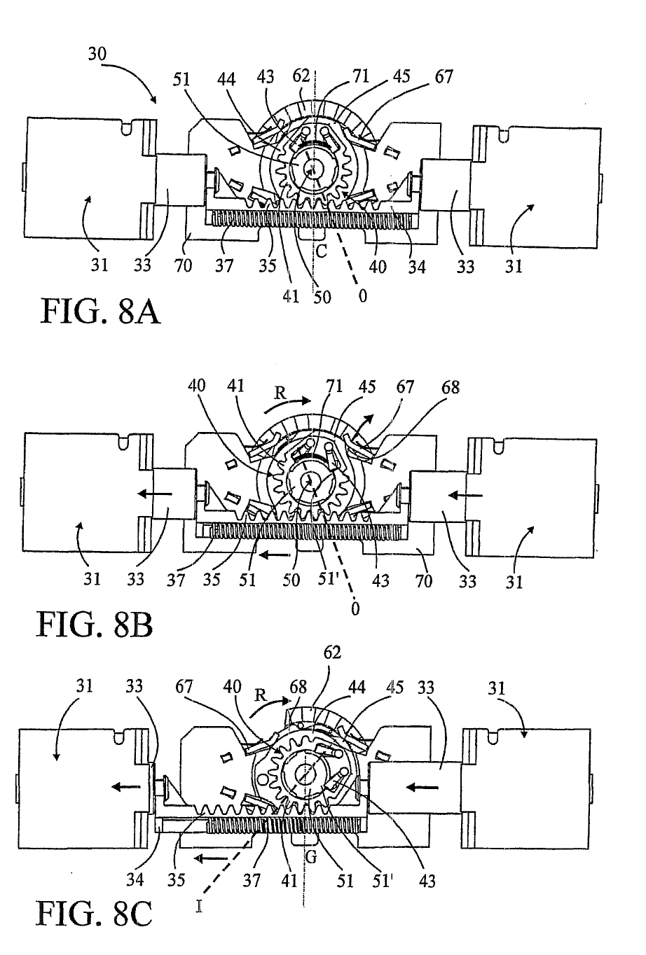

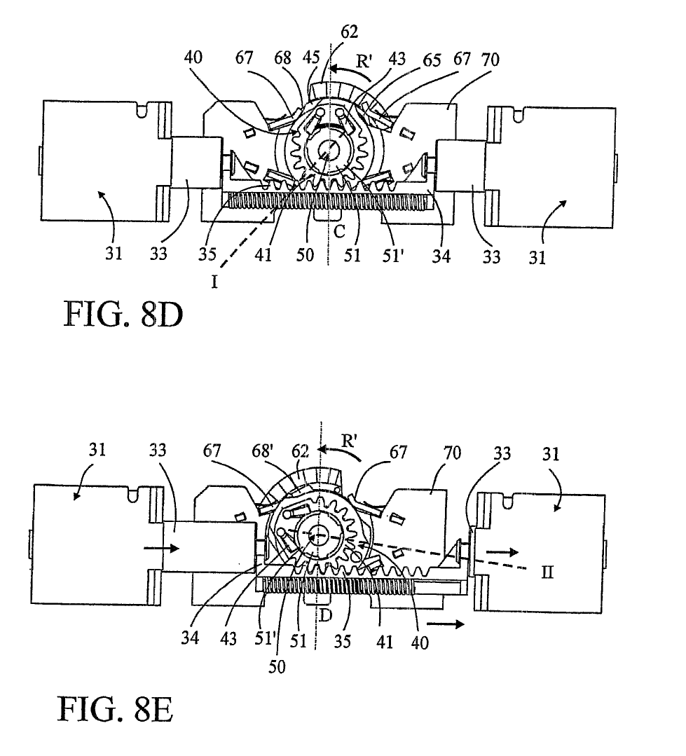

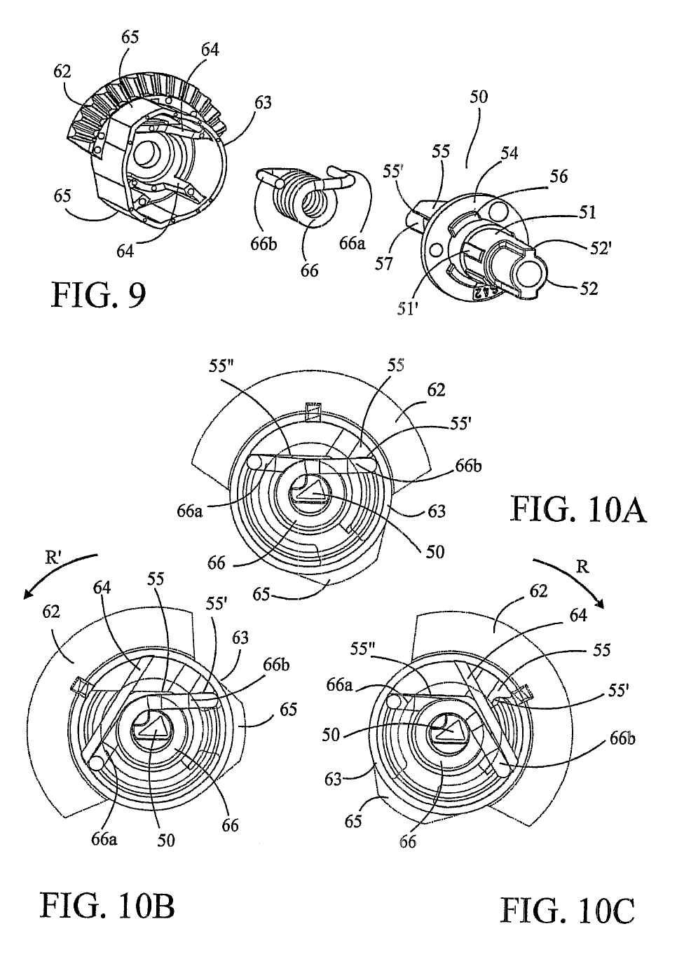

The automated actuation mechanism 30 includes a translation actuator coupled to a device converting the translation movement of the actuator into a rotary movement that will be transmitted to the drive shaft of the cut-off apparatus 1 by a transmission device. In the represented example, the actuator includes two electromagnets 31, arranged aligned and in opposition. Each electromagnet 31 includes in a known way an electricity-powered induction coil 32 and a plunger 33 which is mobile between an out or idle position when the induction coil 32 is not excited and an in or work position when the induction coil 32 is excited, the return movement to the out position being carried out by return means. The induction coils 32 are advantageously powered directly by the cut-off apparatus 1 by means of specific voltage taps (not represented), ensuring the energetic autonomy of the control module 10. The end of the plunger 33 of each electromagnet 31 is coupled to one and the same slide 34 bearing a rack 35. This rack 34 can move in translation between three positions with respect to the housing 11: a stable central position C when the electromagnets 31 are not powered electrically, a left position G when the left electromagnet 31 is excited and a right position D when the right electromagnet 31 is excited. At least the central position C is indexed with a pin 36 (see FIG. 5) provided on the side of the slide 34 and cooperating with a V-shaped spring leaf (not represented) provided in the housing 11. Any other indexing means is of course possible. The means returning the plungers 33 to their out position are, in the represented example, made of a helical compression spring 37 arranged between the housing 11 and the slide 34 (see FIG. 8) and they allow returning the slide 34 in its central position C when the electromagnets 31 are not powered any more. These return means can be made of any equivalent spring element arranged between the slide 34 and the housing 11, between the plungers 33 and the housing 11 or between the plungers 33 and the fixed part of the electromagnets 31. Any other arrangement of the electromagnets 31 and of the slide 34 may be suitable, knowing that the arrangement as it is illustrated allows limiting the space requirement and the dimensions of the control module 10. The control module 10 may include only one electromagnet 31 coupled to the slide 34 in the case of a cut-off apparatus 1 with only one direction of rotation.

The device converting the translation movement of the actuator into a rotating movement includes the rack 35 provided on the slide 34 and meshing with a driving pinion 40. In the represented example, this driving pinion 40 includes a toothed sector 41 which extends over an angle of approximately 270°, and a hollow body 42 which extends over the remaining angle, in which two first pawls 43, arranged symmetrically with respect to a median plane passing through the axis of rotation of the driving pinion 40 and oriented in opposite directions, are mounted so that they can pivot. When the slide 34 is in its central position C, the median plane of the driving pinion 40 passes through C. These first pawls 43 are pushed against a first ratchet wheel 51 by return elements (not represented) and they are movable between a passive position in which they are away from the first ratchet wheel 51, and an active position, in which they are resting on it due to the action of the return elements. This driving pinion 40 includes a terminal section 44 provided with bosses making up first cams 45.

The transmission device of the rotary movement of the driving pinion 40 to the drive shaft includes a rotary drive spindle 50 located in the housing 11 and intended to be aligned and coupled directly to the drive shaft of the cut-off apparatus 1 by means of a mechanical coupling 3 at the exit of this housing 11. This drive spindle 50 includes a first section A arranged to cooperate with the automated actuation mechanism 30 and a second section M arranged to cooperate with the manual actuation mechanism 60 (see FIG. 3).

In its first section A, the drive spindle 50 includes a cylindrical section making up the first ratchet wheel 51 intended to cooperate with the first pawls 43 of the driving pinion 40 whose function is to rotate the drive spindle 50 in one or in the other direction of rotation, according to the excited electromagnet 31, and not to rotate it when this electromagnet 31 is not excited any more and the slide 34 returns automatically in its central position C thanks to the spring 37. The first ratchet wheel 51 bears two pairs of teeth 51′ arranges symmetrically with respect to its median plane, identical to the median plane of the driving pinion 40 when the slide 34 is in its central position C and the cut-off apparatus is in the 0 state.

In its first section A, the drive spindle 50 includes, between the housing 11 and the first ratchet wheel 51, a coupling section 52 provided with two diametrical axial ribs 52′, which can penetrate in the hub 81 of a locking disk 80 to drive it in rotation. Any other rotary link form is possible. This locking disk 80, which is described in detail below, includes a terminal section 82 guided in rotation in a bore of the housing 11, is provided with a groove 82′ able to receive the corresponding rib of a mechanical coupling part 3 in order to ensure a direct rotary link with the drive shaft of the cut-off apparatus 1. Any other coupling form is naturally possible.

The manual actuation mechanism 60 includes an input pinion 61 provided with the receptacle 15 accessible on the front side of the control module 10 under the cover 12 to insert the wrench 14 allowing the operation. This input pinion 61 meshes with an output pinion 62 which is coaxial with the drive spindle 50 in its second section M. These input 61 and output 62 pinions make up a bevel gear pair. The output pinion 62 is made up of a toothed sector of approximately 150° fastened on a sleeve 63 provided inside with axial ribs 64 and outside with two bosses making up second cams 65. The output pinion 62 transmits the rotation of the input pinion 61 to the drive spindle 50 by means of a torsional spring 66 mounted coaxially on a guide section 53 of this drive spindle 50, resting axially in a receptacle 55″ of a disk-shaped section 54. This torsional spring 66 belongs to a snap-action system which ensures a quick switching of the cut-off apparatus 1 in manual mode. It includes two legs 66a and 66b resting radially respectively against an axial rib 64 of the sleeve 63 and in a receptacle 55′ of a radial wall 55 extending from the disk-shaped section 54 at a distance from the guide section 53. The snap-action system includes a retardation device arranged so as to allow the rotation of the drive spindle 50 only as from a predetermined compression threshold of the torsional spring 66, reached as from a predetermined stroke of the input 61 and output 62 pinions. This retardation device includes second pawls 67 mounted in order to rotate in an intermediate wall 70, which is fixed with respect to the housing 11, and a second ratchet wheel 68 linked with the drive spindle 50. This second ratchet wheel 68 is arranged between the intermediate wall 70 and the disk-shaped section 54 of the drive spindle 50, with which it is rotationally linked by means of notches 68″ fitting with blocks 56 provided on the disk-shaped section 54 or similar. It can also be integrated in the drive spindle 50 to form only one part with the latter. This second ratchet wheel 68 includes three teeth 68′ distributed at an equal distance and which can cooperate with the second pawls 67, four in number, distributed by pairs of pawls oriented in opposite directions, symmetrically with respect to the drive spindle 50. The second pawls 67 of a same pair are pushed against the second ratchet wheel 68 by a U-shaped spring leaf 69 located in the intermediate wall 70, and they are movable between a passive position in which they are away from the second ratchet wheel 68, and an active position, in which they are resting on it due to the action of the spring leaf 69. To that purpose, each second pawl 67 has, on its free edge, cut-outs delimiting several sectors 67a-67c: the sector 67a makes up a first wing to follow the second cams 65 of the output pinion 62 causing the spreading of the second pawls 67 and releasing the rotation of the drive spindle 50, the sector 67b makes up a stop for the teeth 68′ of the second ratchet wheel 68 and to inhibit the rotation of the drive spindle 50 and the sector 67c makes up a second wing to follow the first cams 45 of the driving pinion 40 causing the spreading of the second pawls 67 and releasing the rotation of the drive spindle 50 during the operation of the automated actuation mechanism 30.

The combination of the first cams 45 of the driving pinion 40 and of the second pawls 67 thus allows disengaging automatically the manual actuation mechanism 60 when the automated actuation mechanism 30 is in operation. In this case, the drive spindle 50 can rotate freely without the torsional spring 66 being under load, since the input 61 and output 62 pinions are reversible. Conversely, when the manual actuation mechanism 60 is in operation, the automated actuation mechanism 30 is automatically disengaged by means of a retaining lip 71 provided on the intermediate wall 70, forming a stop for the first pawls 43, keeping them away from the first ratchet wheel 51. This retaining lip 71 extends on an angular sector of approximately 90° and allows the drive spindle 50 to turn freely without any action on the driving pinion 40.

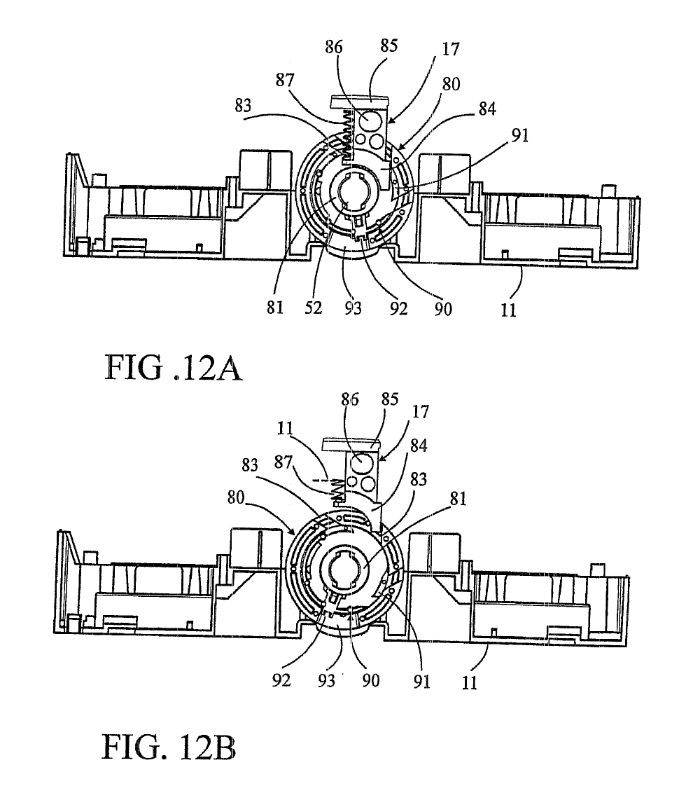

The control module 10 includes padlocking means to prevent the switching of the cut-off apparatus 1. These padlocking means include the locking disk 80, which is rotationally coupled to the drive spindle 50, coupled directly to the drive shaft of the cut-off apparatus 1, and provided with locking notches 83 which can receive the locking finger 84 of the padlocking tab 17 in locked position to prevent it from rotating. This padlocking tab 17 is accessible on the font side of the housing 11 under the cover 12. It is movable in translation perpendicularly to the locking disk 80 between a locked position obtained by pulling manually a handle 85 to pull it out and have access to the locking hole 86 (see FIGS. 2 and 12B) in which the operator can insert a padlock (not represented), and an unlocked position obtained by means of a compression spring 87 which pulls the padlocking tab 17 back to its in position (see FIG. 12A), or by any other equivalent spring element. The locking disk 80 includes three locking notches 83 oriented radially at an angle and passing through its peripheral wall. They are positioned in order to correspond to the three switching states of the cut-off apparatus 1: I, 0, II, so as to offer the possibility to padlock the control module 10 in one of its states. A safety ring 90 is provided inside of the locking disk 80 to inhibit the padlocking in one or in the other switching state. It includes to that purpose a peripheral wall forming a mask 91 to close one or the other locking notch 83. It is movable in rotation with respect to the locking ring 80 by means of a tool (not represented) introduced in a notch 92 accessible through a slot 93 underneath the housing 11. In FIG. 12A, the safety ring 90 is not operating, while, in FIG. 12B, it only allows padlocking in the central locking notch 83 corresponding to the 0 state of the cut-off apparatus 1. The locking ring 80 can include, on its peripheral wall, in front of the window 16 on the front side of the housing 11, a marking (not represented) that allows indicating the switching state: I, 0, II, of the cut-off apparatus 1 according to the angular position of this disk.

The control module 10 also includes means to drive the control of the electromagnets 31. These controlling means include an indexing disk 95 mounted at the free end 57 of the drive spindle 50, with which it is linked in rotation by means of a non cylindrical complementary fitting shape. This indexing disk 95 extends on an angular sector of approximately 180° and has marks such as notches 96 on the periphery, which cooperate with one or several detectors (not represented) provided in the housing 11 which send the information to an electronic board who manages the electrical power supply of the electromagnets 31. In the illustrated example, these notches 96 are three in number and correspond to the three switching states of the cut-off apparatus 1. These three switching states are also indexed mechanically by means of a V-shaped spring leaf 97 fastened on the housing 11 and which can fit in corresponding slots 98 provided in the hub 99 of the indexing disk 95. The detectors operate as limit switches, by optical detection or by other means, to switch off the power supply of the concerned electromagnet 31 as soon as the switching position to be reached is reached. Of course, any other embodiment of the indexing and of the detection of the angular position of the drive spindle 50, and thus of the switching state of the cut-off apparatus 1, can be contemplated.

The operation of this control module 10 is described in detail, primarily referring to FIGS. 8A-E who illustrate the automated actuation mechanism 30, seen from the end of the drive spindle 50, on the side of the cut-off apparatus 1. They show the two electromagnets 31, the slide 34 and its rack 35, the driving pinion 40, the first pawls 43 and the first ratchet wheel 51. They also show, in dashed lines, the angular position of the drive shaft of the cut-off apparatus 1.

In FIG. 8A, the automated actuation mechanism 30 is idle and the cut-off apparatus is in the 0 state: no electromagnet 31 is powered, the plungers 33 are in the out position, the slide 34 is in its stable central position C, its spring 37 is idle, the rack 35 meshes with the motionless driving pinion 40, its median plane passing through C, the first pawls 43 are in their passive position, lifted by the retaining lip 71, the drive spindle 50 is motionless, its median plane passing through C.

In FIG. 8B, the automated actuation mechanism 30 is in operation, but the cut-off device 1 is still at the state 0: the electromagnet 31 located left on the Figs. is powered electrically, the plunger 33 starts retracting, driving the slide 34 towards the left compressing the spring 37, the rack 35 rotates the driving pinion 40 in the clockwise direction R by approximately 15°, the first pawl 43 on the right leaves the retaining lip 71 to mesh with a tooth 51′ of the first ratchet wheel 51. Simultaneously, the first cams 45 of the driving pinion 40 lift the concerned second pawls 67 to release the rotation of the second ratchet wheel 68.

In FIG. 8C, the automated actuation mechanism 30 is still in operation and the cut-off device 1 changed its state switching from state 0 to state I: the electromagnet 31 located left is powered electrically, the plunger 33 is retracted, the slide 34 is on the left side G, the spring 37 is compressed, the rack 35 rotated the driving pinion 40 in the clockwise direction R by approximately 45° driving the first ratchet wheel 51 thanks to the first pawl 43 on the right side 43 who meshed with one of its teeth 51′, the drive spindle 50 transmits this rotation directly to the drive shaft of the cut-off device 1, which switches.

In FIG. 8D, the automated actuation mechanism 30 is idle, but the cut-off device remained in state I: the electromagnet 31 located left is not powered any more, the spring 37 released, bringing the slide 34 back to its central position C and the plungers 33 to their idle position, the rack 35 rotated the driving pinion 40 in the opposite direction R′ to bring it back to its initial position (FIG. 8A), the first pawls 43 spread passing over the teeth 51′ of the first ratchet wheel 51 without driving it, the drive spindle 50 did not move, remaining in its angular position corresponding to state I of FIG. 8C.

The automated actuation mechanism 30 is ready for a new operating cycle. It allows, powering electrically the electromagnet 31 located right, to turn the first ratchet wheel 51 in the opposite direction R′ to change the state of the cut-off apparatus 1 and bring it back to its 0 state, then, still activating the electromagnet 31 located right, to change its state once more to switch it from state 0 to state II, as illustrated in FIG. 8E.

The above-described operating phases are carried out in a very short time, of the order of some milliseconds, the time required for an electrical pulse. This automated actuation mechanism 30 thus allows obtaining a very fast electrical switching in the cut-off modules 2 and eliminates the need for the snap-action system. Of course, the electromagnets 31 are controlled selectively by an electronic board (not represented), which is integrated in the housing 11 and controlled by the controlling means according to the angular position of the drive spindle 50. This control module 10 thus allows, with the help of a monostable pulse control, to control a cut-off apparatus 1 having three stable positions: I-0-II or I-I+II-II, or more. It also allows controlling a cut-off apparatus 1 having two stable positions: I-0 or I-II. The same result can be obtained using a control module 10 equipped with one single electromagnet 31. In this case, the first ratchet wheel 51 is provided with teeth 51′ distributed regularly all along its periphery to cooperate with one single first pawl 43, so as to rotate the drive spindle 50 in the same direction of rotation.

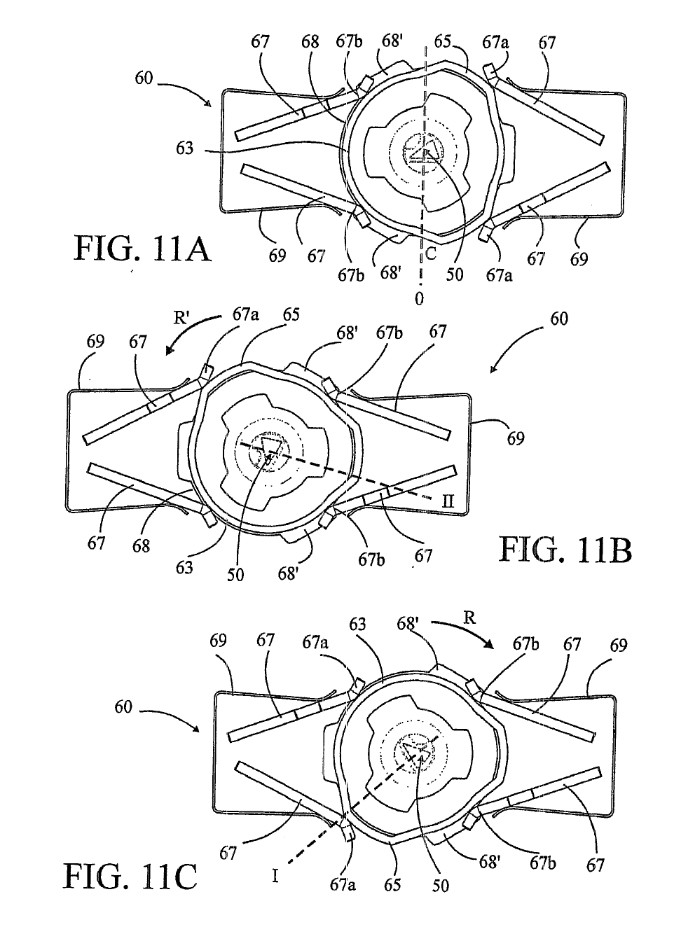

The operation of this control module 10 will now be described in detail referring to FIGS. 11A-C, which illustrate the manual actuation mechanism 60. They show the second ratchet wheel 68, the second pawls 67, their spring leaf 69, the sleeve 63 and the second cams 65 of the output pinion 62 and, in dashed lines, the drive spindle 50. They do not show the input pinion 61, neither the wrench 14 used to rotate it. The operation is also described referring to the FIGS. 10A-C, which illustrate the torsional spring 66 of the snap-action system. These figures show, by transparency, the sleeve 63 and its internal axial ribs 64, the torsional spring 66 and its legs 66a, 66b, the drive spindle 50, its disk-shaped section 54 and its radial wall 55.

When the automated actuation mechanism 30 is not in operation, i.e. when the control module 10 is in manual mode, the first pawls 43 are in passive position, being held away from the first ratchet wheel 51 by the retaining lip 71 of the intermediate wall 70. In this case, the drive spindle 50 can rotate freely without actuating the driving pinion 40 or the rack 35.

In FIGS. 10A and 11A, the manual actuation mechanism 60 is idle and the cut-off apparatus is in the 0 state: the output pinion 62 is in its central position, the second pawls 67 rest against the sleeve 63 due to the action of their spring leaf 69, the second pawls 67 of the left side being meshed with two teeth 68′ of the second ratchet wheel 68, blocking its rotation in both directions, the torsional spring 66 is idle, the drive spindle 50 is motionless.

In FIG. 10B, the manual actuation mechanism 60 is in operation and the cut-off device 1 is still at the state 0: the output pinion 62 rotated towards left in the counter-clockwise direction R′ by an angle of approximately 60° due to the manual action of an operator on the wrench 14 to rotate the input pinion 61 by a corresponding angle, the second ratchet wheel 68 remains immobilized by the seconds pawls 67 who mesh with its teeth 68′, the torsional spring 66 is compressed, its leg 66a being moved by the axial rib 64 of the sleeve 63, the other leg 66b remaining blocked in the receptacle 55′ of the radial wall 55 of the drive spindle 50, which remains motionless.

In FIG. 11B, the manual actuation mechanism 60 is in operation and the cut-off device 1 changed its state, passing from state 0 to state II: the second cams 65 of the output pinion 62 lifted the second pawls 67, which released the ratchet wheel 68, authorizing the rotation of the drive spindle 50 in the same direction R′ under the action of the torsional spring 66. This sudden rotational movement is transmitted directly to the drive shaft of the cut-off device 1, which switches quickly. The second pawls 67 on the right side are now meshed with the teeth 68′ of the second ratchet wheel 68, blocking its rotation in both directions, to allow switching the cut-off apparatus from state II to state 0 by rotating the output pinion 62 in the opposite direction R using the wrench 14 and the input pinion 61. In this case, the torsional spring 66 will again be compressed to obtain a quick switching. These steps are not illustrated.

In FIG. 10C, the manual actuation mechanism 60 is in operation and the cut-off device 1 is in state 0: the output pinion 62 rotated to the right in the clockwise direction R by an angle of approximately 60° due to the manual action of an operator on the wrench 14 to rotate the input pinion 61 by a corresponding angle, the second ratchet wheel 68 remains immobilized by the second pawls 67 which mesh with the teeth 68′, the torsional spring 66 is compressed, its leg 66b being moved by the axial rib 64 of the sleeve 63, the other leg 66a remaining blocked in the receptacle 55′ of the radial wall 55 of the drive spindle 50, which remains motionless.

In FIG. 11C, the manual actuation mechanism 60 is in operation and the cut-off device 1 changed its state and passed from state 0 to state I: the second cams 65 of the output pinion 62 lifted the second pawls 67, which released the ratchet wheel 68 authorizing the rotation of the drive spindle 50 in the same direction R under the action of the torsional spring 66. This sudden rotational movement is transmitted directly to the drive shaft of the cut-off device 1, which switches quickly. The second pawls 67 on the right side are again meshed with the teeth 68′ of the second ratchet wheel 68, blocking its rotation in both directions, to allow switching the cut-off apparatus from state I to state 0 by rotating the output pinion 62 in the opposite direction R′ using the wrench 14 and the input pinion 61. In this case, the torsional spring 66 is again compressed to obtain a quick switching. These steps are not illustrated.

In the case of a cut-off apparatus 1 with only one direction of rotation, since the control module 10 includes only one electromagnet 31, the manual 60 and automated 30 actuation mechanisms are naturally adapted, e.g. the number and angular position of the teeth 68′ of the second ratchet wheel 68 being adapted to the switching angles.

The present invention also relates to the cut-off apparatus 1 as such equipped with a control module 10.

This description shows clearly that the invention allows reaching all the objectives defined. In particular, this control module is designed in a very simple way, compact, with a limited number of parts and with parts that are common to the embodiment variants intended as well for bistable as for tristable cut-off apparatuses, thus at very inexpensive costs. This control module can be adapted on any type of cut-off apparatus 1 equipped with a drive shaft, and it can retrofit already existing apparatuses or be mounted on new apparatuses in the factory. This control module allows reaching very high switching speeds using a simple electrical pulse. It also allows the operation in manual mode without requiring to disengage the automatic mode, which allows for example to switch on automatically and to switch off manually, or vice-versa. This control module also allows a remote control, and it can be associated with any monitoring, failure detection, protection equipment.

The present invention is not limited to the embodiment example described, but it extends to any modification and variant evident for a person skilled in the art, while still remaining within the scope of the protection conferred by the attached claims, as well as to any application and combination possible for this person skilled in the art.

1-21. (canceled)

22. An automated control module (10) for an electrical cut-off apparatus (1) having a rotary drive shaft, the control module (10) comprising a housing (11) in which an automated actuation mechanism (30) is seated for rotation of a control axis, a translation actuator (31), a device (35, 40) for converting translational movement of the translation actuator (31) into a rotary movement and a device (43, 50) for transmitting the rotary movement to the drive shaft, the translation actuator (31) includes at least one electromagnet (31), the conversion device includes at least one slide (34) coupled to the electromagnet (31), and is provided with a rack (35) meshing with a driving pinion (40), the driving pinion (40) being coupled to the drive shaft via the transmission device (43, 50) when the control module (10) is assembled with the cut-off apparatus (1).

23. The module according to claim 22, wherein the electromagnet (31) includes a plunger (33) coupled to the at least one slide (34) and the plunger (33) is pulled back in an idle position by return means (37) when the electromagnet (31) is not powered electrically.

24. The module according to claim 23, wherein the return means (37) is arranged between the housing (11) and the at least one slide (34).

25. The module according to claim 22, wherein the automated actuation mechanism (30) includes two electromagnets (31) aligned in opposition to one another and coupled to a common slide (34).

26. The module according to claim 22, wherein the transmission device includes a drive spindle (50), which is rotationally coupled to the drive shaft, and a first ratchet wheel (51), and at least a first pawl (43) associated with a return element, fastened to the driving pinion (40) and arranged to cooperate with the first ratchet wheel (51) to drive the first ratchet wheel (51) in at least in one rotational direction.

27. The module according to claim 26, wherein the transmission device includes two first pawls (43) oriented in opposite directions and arranged to cooperate with the first ratchet wheel (51) to drive the first ratchet wheel (51) in both rotational directions.

28. The module according to claim 22, wherein the translation actuator is powered electrically directly by the cut-off apparatus (1) with which the translation actuator is associated.

29. The module according to claim 26, wherein the translation actuator is controlled by a controlling means according to the angular position of the drive spindle (50).

30. The module according to claim 29, wherein the controlling means include an indexing disk (95) linked with said drive spindle (50), provided with marks corresponding to switching states of the cut-off apparatus (1) and with means for the detection of the marks.

31. The module according to claim 26, wherein the control module includes a locking disk (80) linked with the drive spindle (50) and a padlocking tab (17) accessible at an outside of the housing (11) to be moved manually between a locked position, in which the padlocking tab (17) prevents the locking disk (80) from rotating, and an unlocked position, in which the padlocking tab (17) allows rotation of the locking disk (80).

32. The module according to claim 31, wherein the locking disk (80) includes locking notches (83) corresponding to switching states of the cut-off apparatus (1) and the padlocking tab (17) includes a locking finger (84), which fits into one of the locking notches (83) in a locked position.

33. The module according to claim 32, wherein the control module includes a safety ring (90) associated with the locking disk (80) and is provided with a mask arranged to close one of one locking notch (83) or another according to an adjustable angular position of the safety ring (90) with respect to the locking disk (80).

34. The module according to claim 26, wherein the control module includes a manual actuation mechanism (60), located in the housing (11), aligned with the automated actuation mechanism (30), the manual actuation mechanism (60) having a gripping element (14), which is operable by an operator from outside of the housing (11), and a transmission device (61, 62, 66, 68) to the drive spindle (50).

35. The module according to claim 34, wherein the transmission device includes an input pinion (61) driven by the gripping element (14), meshing with an output pinion (62) coupled to the drive spindle (50) by a snap-action system (66, 68) arranged to quickly switch the cut-off apparatus (1).

36. The module according to claim 35, wherein the snap-action system includes a torsional spring (66), which is coaxial with the drive spindle (50) and seated in a sleeve (63) fastened to the output pinion (62), legs (66a, 66b) of the torsional spring (66) abut stops (55, 64) provided on the drive spindle (50) and in the sleeve (63).

37. The module according to claim 36, wherein the snap-action system includes a second ratchet wheel (68) linked with the drive spindle (50) and at least two second pawls (67), which are associated with a return element (69), fastened to the housing (11), oriented in opposite directions and arranged to cooperate with the second ratchet wheel (68).

38. The module according to claim 37, wherein the at least two second pawls (67) include a first wing (67a), which engages a second cam (65) fastened to the output pinion (62) so as to spread the second pawls (67) and release the rotation of the second ratchet wheel (68).

39. The module according to claim 37, wherein the control module includes an intermediate wall (70) located in the housing (11), passed through by the drive spindle (50) and arranged to bear the second pawls (67) and the associated return element (69).

40. The module according to claim 39, wherein the intermediate wall (70) includes a retaining lip (71) arranged to spread the first pawls (43) and release the rotation of the first ratchet wheel (51) to disengage the automated actuation mechanism (30).

41. The module according to claim 37, wherein the second pawls (67) include a second wing (67c), which engages a first cam (45) provided on the driving pinion (40) in order to spread the second pawls (67) and release the rotation of the second ratchet wheel (68) to disengage the manual actuation mechanism (60) when the automated actuation mechanism (30) is in operation.

42. A control module (10) in combination with an electrical cut-off apparatus (1) including a rotary drive shaft, the control module (10) comprising a housing (11) in which an automated actuation mechanism (30) is seated for rotation of the control axis, a translation actuator (31), a device (35, 40) converting translational movement of the translation actuator (31) into a rotary movement and a device (43, 50) transmitting the rotary movement to the drive shaft, the translation actuator (31) includes at least one electromagnet (31), the conversion device includes at least one slide (34) coupled to the electromagnet (31), and is provided with a rack (35) meshing with a driving pinion (40), the driving pinion (40) being coupled to the drive shaft via the transmission device (43, 50) when the control module (10) is assembled with the cut-off apparatus (1).
